(19) United States
(12) Patent Application Publication
(10) Pub. No.: US 2009/0083152 A1
(43) Pub. Date: Mar. 26, 2009

(54) SYSTEM AND METHOD FOR PROVIDING PROMOTIONAL INFORMATION USING DISPENSED PAPER

(76) Inventors: Stone Melet, San Francisco, CA (US); Neil Alford, Mill Valley, CA (US); Robert Alford, New Orleans, LA (US)

Correspondence Address: MCKENNA LONG & ALDRIDGE LLP, 1900 K STREET, NW, WASHINGTON, DC, 20006, US

(21) Appl. No.: 12/108,300

(22) Filed: Apr. 23, 2008

Related U.S. Application Data
(60) Provisional application No. 60/974,251, filed on Sep. 21, 2007.

(51) Int. Cl. G06Q 30/00

(52) U.S. Cl. 705/14

(57) ABSTRACT

Disclosed is a system and method for providing promotional information to potential customers. The system includes a dispensing terminal, which dispenses receipts that have game piece surfaces disposed on them. The customer may remove the game piece to reveal promotional information, including prizes or prize information may be revealed to the customer once he has viewed a website. The promotional information may include a website, through which the customer may log on or visit to see if he/she has won a prize. The website may provide additional promotional information to the customer, some of which may be provided by multiple promotion providers. In a variation of the system, the game piece surface conceals information encouraging the customer use his/her cell phone to send a text message to a specified number, along with a response to the promotional information. The system receives the text message and compares the entry code with codes that correspond to a winning entry. The prize is related to a sales promotion.

This application claims the benefit of provisional Application No. 60/924,251, filed May 4, 2007, which is incorporated by reference herein in its entirety.

### BACKGROUND OF THE INVENTION

1. Field of the Invention

The present invention generally relates to the delivery of promotional information. More particularly, the present invention relates to the delivery of promotional information using receipts dispensed in consumer transactions, for example, from a dispensing terminal such as an ATM transaction or point of sale transaction.

2. Discussion of the Related Art

There are approximately 1.5 million automated teller machines (“ATMs”) throughout the world. Approximately 400,000 of these are located in the U.S.A. typical ATM may engage in many transactions per day. For each transaction, the ATM provides the customer with a receipt, which the customer typically retains for his or her records.

There are still more point of sale (POS) terminals, for example, cash registers or credit card terminals, in which customers receive receipts for the transaction.

The ATM or POS receipt may be used to provide promotional information, such as advertising, and the like.

Related art approaches to using an ATM or POS to provide promotional information involve printing information on receipts. However, the available area on a receipt is small. As such, the amount of information that can be provided on the ATM or POS receipt is generally limited.

Accordingly, what is needed is a way to place promotional information on an ATM or POS receipt such that the information on the receipt can lead the customer to secondary sources of information, which provide further promotional information that cannot be printed on the receipt.

### SUMMARY OF THE INVENTION

The present invention provides a system and method for providing promotional information using receipts from a dispensing terminal such as automated teller machine or point of sale terminal that obviates one or more of the aforementioned problems due to the limitations of the related art.

Accordingly, one advantage of the present invention is that it improves an advertiser's ability to reach more potential customers.

Another advantage of the present invention is that it allows more promotional services to access a customer from a single transaction.

Additional advantages of the invention will be set forth in the description what follows, and in part will be apparent from the description, or may be learned by practice of the invention. The advantages of the invention will be realized and attained by the structure pointed out in the written description and claims hereof as well as the appended drawings.

To achieve these and other advantages, the present invention involves a method of providing promotional information. The method comprises installing a plurality of receipts, wherein each of the plurality of receipts has a game piece that is disposed thereon at a dispensing terminal; providing at least one of said receipts to a customer; and providing promotional information to the customer wherein said promotional information is hidden by said game piece and is revealable by the customer.

In another aspect of the present invention, the aforementioned and other advantages are achieved by a method of providing promotional information to a customer. The method comprises installing a plurality of receipts, each having wireless communication service information preprinted thereon, at a dispensing terminal; receiving communication from a customer, who has received one of the plurality of receipts, via the wireless communication service; storing information corresponding to the customer; and providing the information corresponding to the customers who have communicated via the wireless communication service to a promotion provider.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an exemplary system for providing promotional information using automated teller machines according to the present invention; and

FIG. 2A illustrates an exemplary receipt according to the present invention.

FIGS. 2B, 2C 2D illustrate structures of still other exemplary receipts.

FIG. 3-6 illustrate exemplary processes according to the present invention.

### DETAILED DESCRIPTION OF THE ILLUSTRATED EMBODIMENTS

The present invention involves using a specially-printed ATM or POS receipt to provide information to the customer regarding promotional information. The promotional information may include website information, whereby the customer may subsequently use his/her computer to gain access to the website.

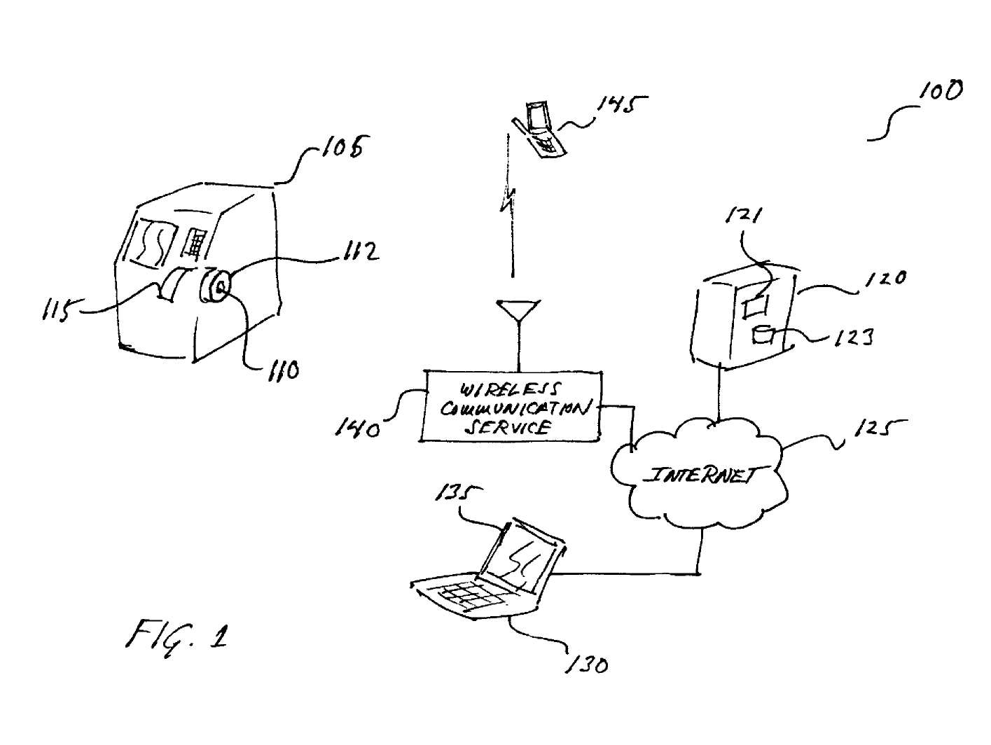

FIG. 1 illustrates an exemplary system 100 according to the present invention. System 100 includes a dispensing terminal, such as an ATM or POS terminal 105, which has a receipt paper roll 110. Receipt paper roll 110 may be a standard receipt paper roll that is commercially available for the ATM or POS terminal. Receipt paper roll 110 may have a plurality of receipt segments 115, which may be formed end-to-end on a single piece of receipt paper 112. Receipt paper 112 may be standard receipt paper that is commercially available. System 100 also includes a host computer 120, which has a processor 121 and a memory device 123. Host computer 120 may be connected to the Internet or a network 125. A client computer 130, which has a screen 135 may also be connected to Internet 125. One of skill in the art would appreciate that, while an automated teller machine 105 is illustrated in FIG. 1, a point of sale (POS) terminal may be substituted for the ATM 105 without departing from the spirit and scope of the present invention.

System 100 may also include a wireless communication service 140, which provides a communications link with a customer via the customer's cell phone 145. Wireless communication service 140 may communicate with host computer 120 via the internet 125 or other known interface.

Host computer 120 may include one or more computers that host a website according to the present invention. If host computer 120 includes more than one computer, one or more of the other computers may be remotely located and connected over internet 125. Memory device 123 may include one or more memory components, which may be integrated within host computer 120 or distributed among other computers that are connected over internet 125. Memory device 123 is encoded with computer readable instructions and data (hereinafter the “software”) for implementing processes according to the invention. The system may include a dispensing terminal, which dispenses receipts that have game piece surfaces disposed on them. The customer may remove the game piece to reveal promotional information, including prizes, or prize information may be revealed to the customer once he has viewed a website. The promotional information may include a website, through which the customer may log on or visit to see if he/she has won a prize. The website may provide additional promotional information to the customer, some of which may be provided by multiple promotion providers. In a variation of the system, the game piece surface conceals information encouraging the customer use his/her cell phone to send a text message to a specified number, along with a response to the promotional information. The system receives the text message and compares the entry code with codes that correspond to a winning entry. The prize is related to a sales promotion.

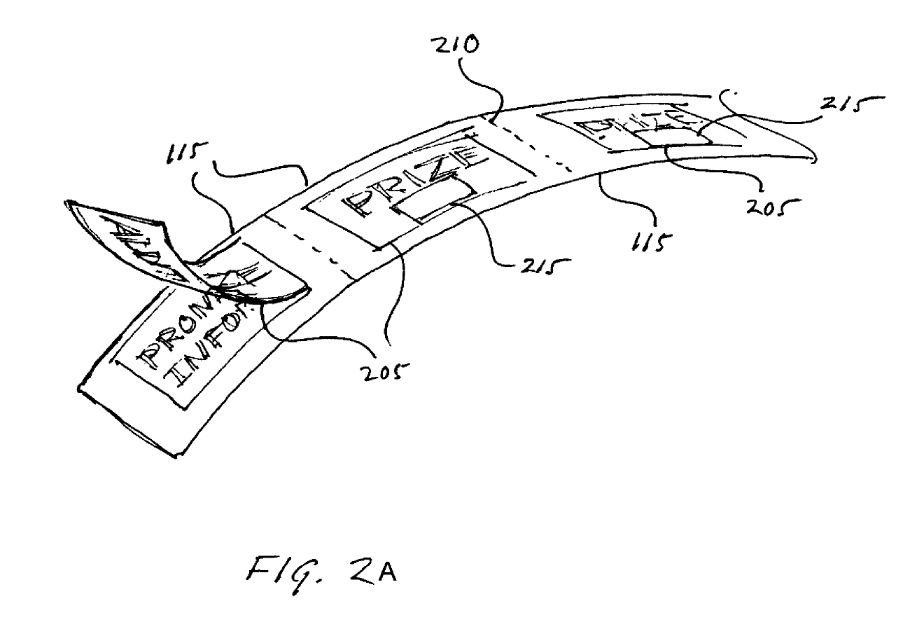

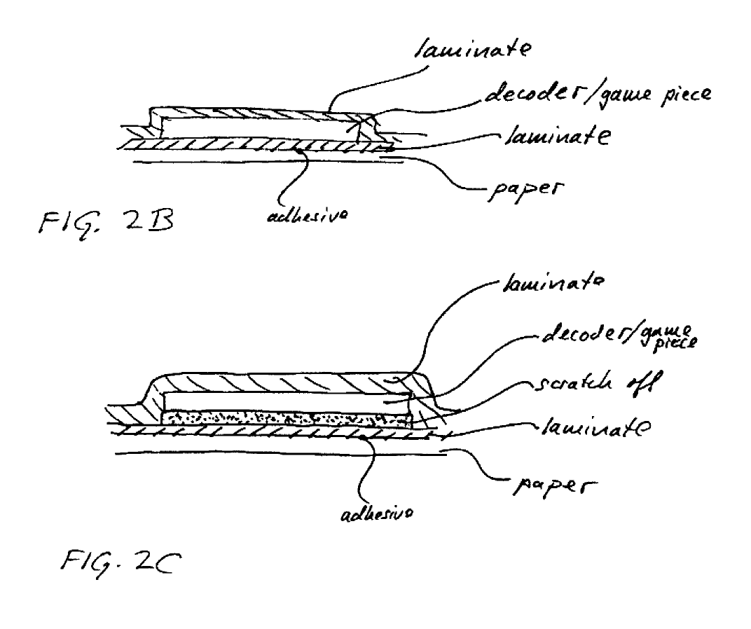

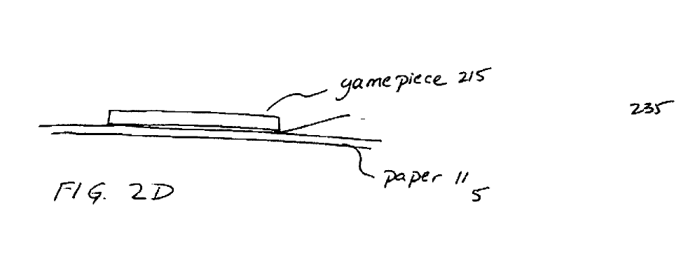

FIG. 2 illustrates a plurality of exemplary receipts 115 according to the present invention. Receipt 115 may include a game piece surface 205, which may cover the entire surface of one side of receipt 115. Alternatively, game piece surface 205 may cover an area that is a subset of the area of one side of receipt 115. Game piece surface 205 may include a game piece device 215. As mentioned above, receipts 115 may be formed of one piece of receipt paper 112, whereby each individual receipt 115 may be connected by a perforation 210 in receipt paper 112.

Game piece surface 205 may be disposed on receipt 115 such that when receipt 115 is dispensed by ATM 105 or POS terminal, game piece surface 205 will be on the underside of receipt 115. Game piece surface 205 may include a game piece device 215, which may include a decoder or descrambler-style game piece, which may have a color-tinted transparent plastic material. An exemplary game piece device 215 may be like that manufactured by WebDecoder.com (a.k.a. Global Commerce Group, Inc.) of Cumming, Ga., USA or by WS Packaging Group Inc. of Algoma, Wis. The use of a decoder-style game piece device 215 is described further below. Other types of game piece devices 215 may be used. For example, game piece device 215 may include a scratch-off surface, like that found on a lottery ticket. A combination of game pieces may also be used on a single receipt, for example a scratch-off and a decoder-style game piece.

As illustrated in FIG. 2, receipt 115 and game piece surface 205 may be printed with information pertaining to promotions or games. For example, the surface of receipt 115 underneath game piece surface 205 may include printed information inviting a customer to go to a website for example, directly to a vendor or retailer's website or to an intermediary website offering various promotional data or re-direction to a vendor or retailer's website. Further, printed information on receipt 115 and/or game piece surface 205 may encourage the customer to use his/her cell phone 145 to send a text message to a particular number maintained by wireless communication service 140. The promotional material or game piece may be preprinted on the receipt paper before the dispensing terminal is loaded with the paper.

Game piece device 215 may be plastic piece or token that can be used to play a game. Alternatively, game piece device 215 may be a slip of paper that has promotional information pre-printed on it. The promotional information may include any information that a vendor, retailer, promotion provider, etc. may want to present to the customer. One skilled in the art will readily appreciate that such variations to game piece device 215 are possible and within the scope of the invention.

FIGS. 2B, 2C 2D illustrate exemplary structures of exemplary receipts. For example, FIG. 2B illustrates an exemplary receipt 115 that includes an adhesive 220 and laminate 225 to attach a decoder style game piece device 215. FIG. 2C illustrates a scratch-off style game piece 230 with a decoder style game piece 215 attached using a laminate 225. FIG. 2D illustrates a decoder-style game piece 215 in a “clean release” configuration that may be attached using an adhesive 235. One of skill in the art world appreciate that any combination or sole use of known attachment method would be possible, e.g. clean release, glue rails, etc. One of skill in the art would also appreciate that the decoder-style game piece may be formed of many known materials, including plastic, such as polyproplyne.

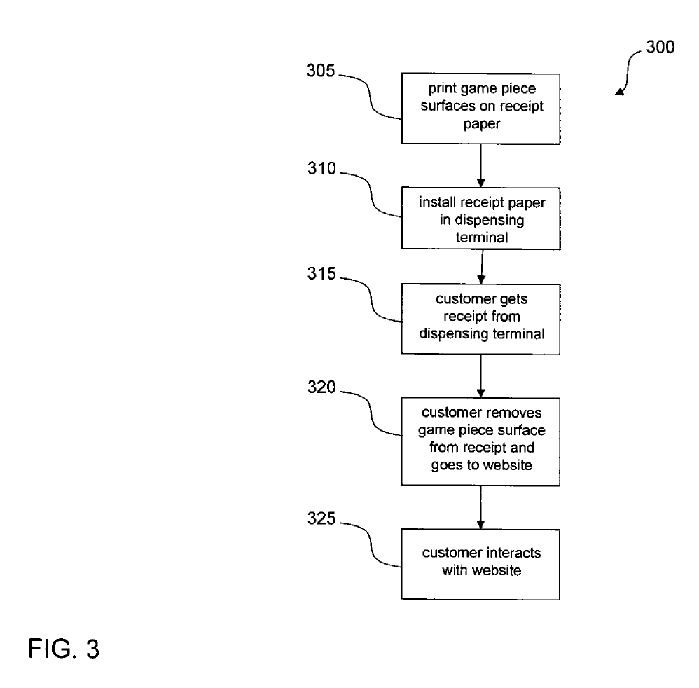

FIG. 3 illustrates an exemplary process 300 for providing promotional information according to the present invention.

At step 305 game piece surface 205 is predisposed on a receipt or receipt paper. In doing so, for example, a decoder-type game piece device 215 may be fabricated and adhered to receipt paper 112. Information and graphics may be printed on receipt paper 112 so that the information and graphics are hidden by game piece surface 205. This way, the information and graphics are revealed only when the customer having the receipt removes game piece surface 205 from receipt 115.

If game piece device 215 is a decoder-style game piece, the decoder-style game piece may be adhered to receipt paper 112 using an adhesive or laminate or by an attachment film in a clean release method.

At step 310, the plurality of receipts 115, formed on receipt paper 112, are installed at a dispensing terminal spooled onto receipt paper roll 110 and illustrated in dispensing terminal 105 of FIG. 1.

At step 315, a customer gets a receipt by, for example, using an ATM for a customary banking transaction or receiving a receipt in a sales transaction. At the end of the transaction, dispensing terminal 105 dispenses the receipt 115. The customer takes the receipt.

At step 320, the customer reveals game piece surface 205 from receipt 115. Game piece surface 205 may include a tab (not shown) by which the customer may pull game piece surface 205 off of receipt 115. In doing so, customer has obtained game piece device 215, and has revealed the graphics and information printed on receipt paper 112 and the underside of game piece surface 205. The customer may also or alternatively “scratch-off” a scratch-off surface to reveal the graphics and information printed in receipt paper 112. The graphic and information may be printed on the receipt paper or on the game piece itself.

Further to step 320, the customer uses client computer 130 to go to a website, according to the information provided on receipt paper 112 the game piece. Thus, the customer may be directed to an advertiser's website, for example a vendor or a retailer, or may be directed to a website to capture information about the customer, as illustrated in FIG. 3.

The website may be maintained by host computer 120 such that the machine readable instructions and data corresponding to the website are stored on memory device 123, and the instructions are executed on processor 121.

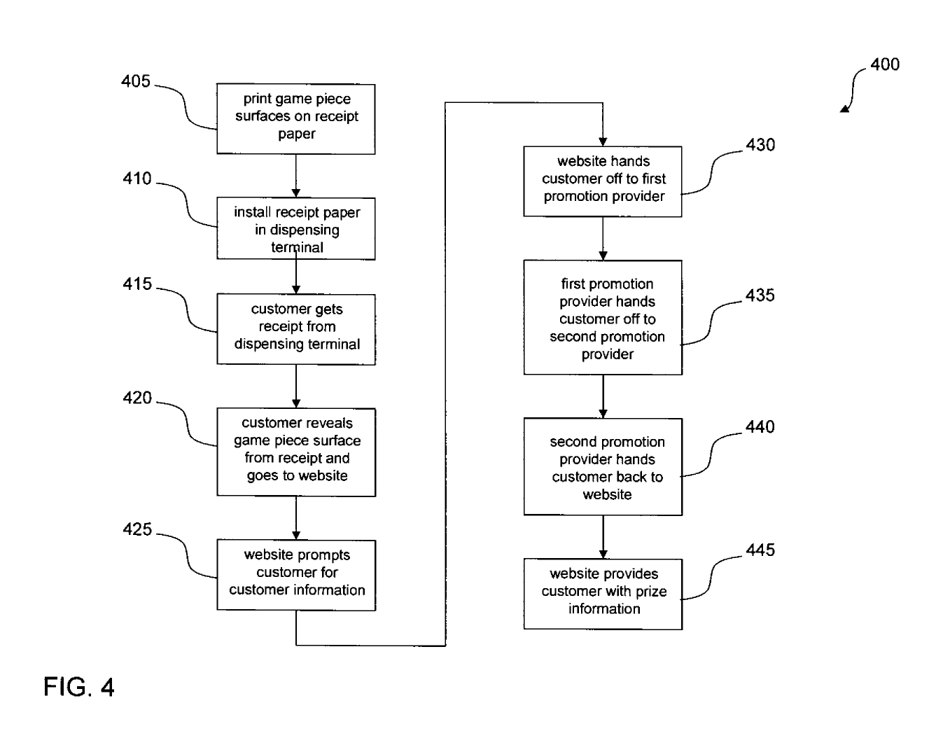

Additional information may be obtained from the customer, as illustrated in FIG. 4. As illustrated in FIG. 4, for example, at step 425, processor 121 executes instructions corresponding to the website to prompt the customer for information. Prompted information may include demographic information, such as gender, age, vocation, address, and the like. The customer may enter the demographic information via client computer 130.

At step 430, processor 121 may execute instructions corresponding to the website to “hand off” the customer to another server, which is operated by first promotion provider. In doing so, server operated by the first promotion provider may begin interacting with the customer in such a way that the customer may not be aware that he/she is no longer interacting with the website hosted by host computer 120. In handing-off the customer, host computer 120 may provider the server operated by first promotion provider with the customer information obtained in step 425.

First promotion provider may interact with the customer, providing the customer with promotional information and possibly making sales.

At step 435, the server operated by first promotion provider may hand-off the customer to another server, which is operated by a second promotion provider. The second promotion provider may interact with the customer, in a manner similar to first promotion provider. When done, the second promotion provider may hand-off the customer back to the website hosted by host computer 120.

At step 440, host computer 120 may notify the customer if he/she has won a prize, based on the game piece device 215 obtained from receipt 115. If game piece device 215 is a decode-style game piece, processor 121 may execute instructions corresponding to the website to randomly generate information pertaining to whether the customer has won a prize. Depending on the result of this random generation, processor 121 may select the corresponding image data from memory 123, whereby the image contains information notifying the customer whether or not the customer has won a prize. The image may be invisible to the naked eye, and only visible when viewed through the color-tinted plastic material on descrambler-style game piece 215. One skilled in the art will readily appreciate that techniques for generating and displaying an image are known and within the scope of the invention.

Processor 121 may then execute instructions corresponding to the website to instruct the customer to hold up descrambler-style game piece device 215 to that the color-tinted plastic material is in front of the displayed image. Depending on the displayed image, the customer will be notified whether or not he/she has won a prize. If the customer has won a prize, processor 121 may execute instructions corresponding to the website to obtain further information for providing the prize to the customer.

Further to process 400, each promotion provider may maintain a log of customers who have been led to the promotion provider by the website hosted by host computer 120. Each promotion provider may periodically compensate the operator of host computer, based on the number of customers brought to it in process 400.

Variations to exemplary process 400 are possible and within the scope of the invention. For example, there may be additional promotion providers, to whom the customer may be seamlessly handed-off, in a manner similar to steps 435 and 440. Further, instead of first promotion provider handing-off the customer to the second promotion provider, each promotion provider may hand-off the customer to the website hosted by host computer 120. In this manner, each promotion provider may not be aware of the presence of other promotion providers. Additionally, host computer 120 may store information pertaining to each of the promotion providers in memory 123. This may enable host computer 120 to selectively hand-off customers to specific promotion providers, depending on the customer information obtained in step.

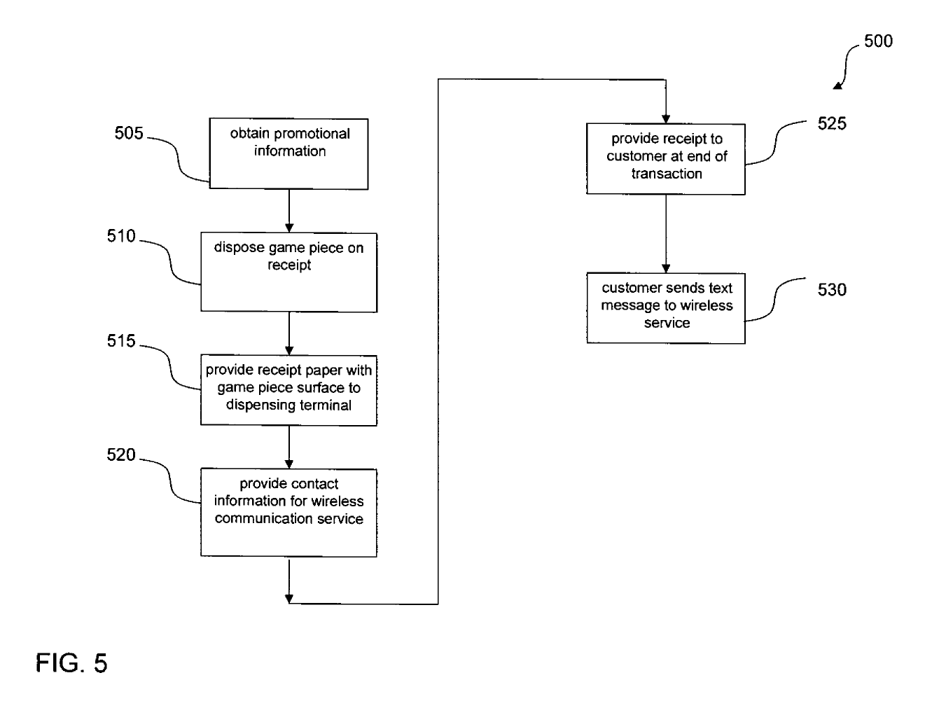

FIG. 5 illustrates an exemplary process 500, in which a customer may send a text message in accordance with instructions printed on game piece surface 205 (or on receipt paper 112 underneath game piece surface 205) according to the present invention. Process 500 may be implemented by an organization that operates host computer 120 and provides receipts 115 to ATMs 105 or POS terminals (hereinafter “operator”), as illustrated in FIG. 1.

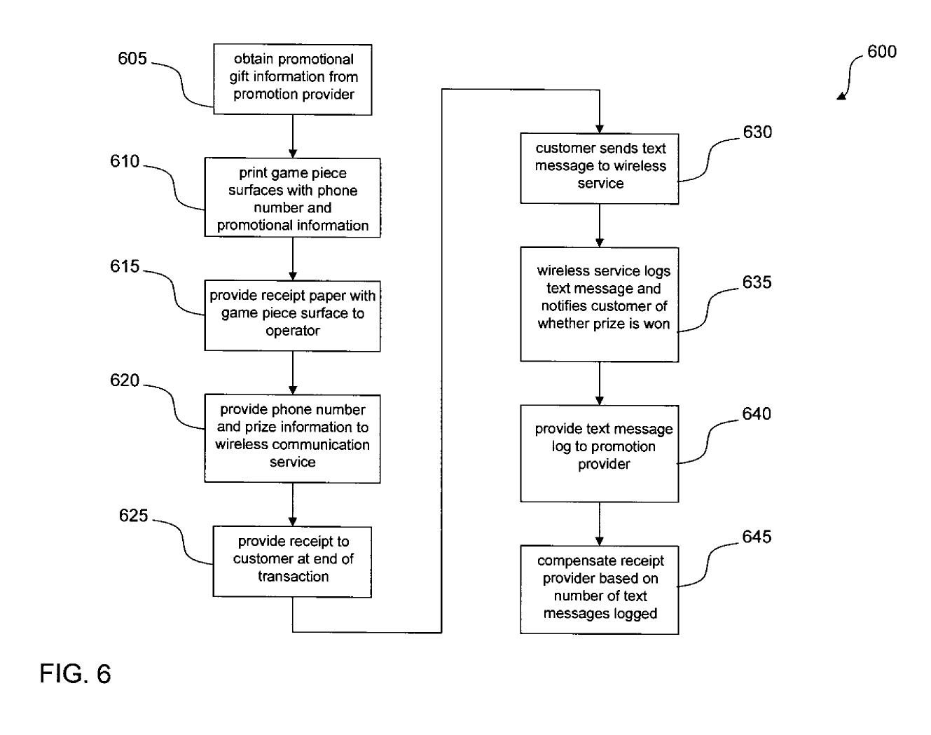

A more specific example of executing a promotion is provided with reference to FIG. 6. At step 605, the operator obtains information from a promotion provider regarding items that are being offered as prizes. For example, a TV manufacturer may have a new model that the TV manufacturer wishes to promote. The TV manufacturer may enlist the services of the promotion provider, whereby the TV manufacturer may give several TVs to the promotion provider to be offered as prizes. The operator may obtain information regarding the model TV, and the number that are available to be given away.

A step 610, the operator prints game piece surfaces 205 having information about the TV, along with instructions for the customer to send a text message to a predetermined phone number along with a key word from among a plurality of key words. The key word may be a code that corresponds to a particular product promotion, such as a promotion for a new model TV, and the like.

Further to step, 610, the operator adheres the game piece surfaces 205 to receipt paper 112 to form a plurality of receipts 115.

At step 415, the operator provides the receipts 115 to the ATM operator, who installs the receipts 115 in a dispensing terminal 105.

At step 620, the operator notifies wireless communication service 140 that a certain number corresponds to a prize drawing. Wireless communication service 140 may be instructed to relay any received text messages to host computer 120. Wireless communication service 140 may further be instructed to send an automatic reply to cell phone 145, download a game to cell phone 145, and the like.

At step 625, dispensing terminal 105 dispenses receipt 115 to customer at the conclusion of a transaction. The customer then may remove game piece surface 205 from receipt 115, revealing instructions to send a text message containing the key word to the number provided to wireless communication service 140 in step 415.

At step 630, the customer sends a text message to wireless communication service 140, along with key word, using customer's cell phone 145.

At step 635, wireless communication service 140 receives the text message, along with the key word, and relays the text message to host computer 140. Processor 121 may execute instructions stored in memory 123 to store the text message and key word in memory 123. Each received text message may be stored according to key word. In doing so, multiple files may be maintained in memory 123, one per key word. Further to step 435, processor 121 may execute instructions to transmit information to wireless communication service 140 along with instructions to relay the information to cell phone 145. The information relayed to cell phone 145 may correspond to the key word, and may include a game, and/or information regarding a promotional prize that is available for bidding.

In response to the information relayed to cell phone 145, the customer may place a bid for the promotional prize. Wireless communication service 140 may relay the bid back to host computer 120, where it may be stored in memory 123.

At step 435, after a predetermined period, in which multiple bids have been received and stored in memory 123, processor 121 may execute instructions to select the lowest unique bid, and then transmit a message to wireless communication service 140 for relaying to the cell phone 145 corresponding to the lowest unique bid. In this exemplary scenario, the lowest unique bidder may win the promotional prize. An example of such a text message-based promotional game is that of Limbo 41414, Inc., Burlingame, Calif. (http://www.41414.com/howtoplay).

The bid provided by the customer may be referred to as promotion response data. Instead of a bid for a promotional prize, the promotional response data may include any information (e.g., answer to a trivia question, hobby or special interest information, and the like). In this case, processor 121 may execute instructions stored in memory 123 to select a winner among received text messages and promotional response data, according to some predetermined criteria. Also, promotion response information data may be optional. In this case, a winner may be drawn randomly based on the phone number corresponding to cell phone 145.

Further to step 635, wireless communication service 140 may obtain information, such as an address, which it relays back to host computer 120 over internet 125. The address may be used for shipping the promotional prize. Wireless communication service 140 may alternatively obtain a shipping address by retrieving the address corresponding to the owner of cell phone 145.

At step 640, wireless communication service 140 may log all of the text messages it receives regarding the promotion. Wireless communication service 140 may also provide this information periodically to host computer 120 over internet 125. Processor 121 on host computer 120 may store this information in memory 123.

Further to step 640, the operator may provide the text message logs obtained from wireless communication service 140 to the promotion provider.

At step 645, the promotion provider may then compensate the operator based on the number of logged text messages.

Variations to process 600 are possible and within the scope of the invention. For example, game piece device 215 may contain information encouraging the customer to send a text message with a specific key word. In response to the text message with the key word, wireless communication service 140 may send an autoreply message to cell phone 145 that encourages the customer to go to a website hosted by host computer 120. The autoreply message may also include information, such as a predetermined character string, which the customer enters at a prompt provided by the website. In response to receiving the predetermined character string, host computer 120 may provide additional information to the customer via client computer 130. This additional information may include information about a periodic (e.g., daily) drawing. Further, processor 121 may execute instructions to receive and additional information regarding the customer via client computer 130, and store this information in memory 123. Processor 121 may subsequently execute instructions stored in memory 123 to randomly select a winner among customers who have provided their information.

In another variation of the present invention, promotional information printed on game piece device 215 may inform an ATM customer that he/she may have their ATM fee refunded. In this case, when the ATM customer interacts with the website, as described in steps 325-345, processor 121 may execute instructions to determine if the ATM customer has accepted any of the promotional offers presented in steps 330-340. If so, processor 121 may execute instructions to display information to ATM customer via client computer 130 that the ATM customer is entitled to a refund of his/her ATM fees (along with other optional prizes). Processor 121 may further execute instructions to obtain information from the ATM customer necessary to credit the ATM customer's credit card, mail a check, or implement some other way of refunding the ATM customer. Other similar refunds or credits may be offered to POS customers.

In another variation of the present invention, the machine dispensing a receipt, may be an ATM, Point of Sale machine, cash register, or similar.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of providing promotional information, comprising:
installing a plurality of receipts, wherein each of the plurality of receipts has a game piece that is disposed thereon at a dispensing terminal;
providing at least one of said receipts to a customer; and
providing promotional information to the customer wherein said promotional information is hidden by said game piece and is revealable by the customer.

2. The method of claim 1, wherein the dispensing terminal is an automated teller machine.

3. The method of claim 1, wherein the dispensing terminal is a point of sale terminal.

4. The method of claim 1, wherein the game piece surface is preprinted on the plurality of receipts.

5. The method of claim 1, wherein the game piece is a decoder-style game piece

6. The method of claim 1, wherein the game piece is a scratch off-style game piece.

7. The method of claim 5, wherein said decoder-style game piece is predisposed on at least one of the plurality of receipts by an adhesive.

8. The method of claim 5, wherein said decoder-style game piece is pre disposed on at least one of the plurality of release by a clean release method.

9. The method of claim 5, wherein said decoder style game piece is predisposed on at least one of the plurality of receipts by glue rails.

10. A method of providing promotional information to a customer, comprising:
installing a plurality of receipts, each having wireless communication service information preprinted thereon, at a dispensing terminal;
receiving communication from a customer, who has received one of the plurality of receipts, via the wireless communication service;
storing information corresponding to the customer; and
providing the information corresponding to the customers who have communicated via the wireless communication service to a promotion provider.

11. The method of claim 10, further comprising receiving a promotion response data from the ATM customer.

12. The method of claim 11, wherein selecting the winning text message comprises selecting a winner based on the promotion response data.

13. The method of claim 10, wherein the dispensing terminal is an automated teller machine.

14. The method of claim 10, wherein the dispensing terminal is a point of sale terminal.

15. The method of claim 10, wherein the communication includes a text message and a key word.

16. The method of claim 10, further comprising selecting a winning customer from among customers who have communicated via the wireless communication service.
